(19) United States
(12) Patent Application Publication
(10) Pub. No.: US 2025/0305529 A1
(43) Pub. Date: Oct. 2, 2025

(54) SEMI-HOLLOW SELF-PIERCING RIVET, MANUFACTURING METHOD AND CONNECTION WITH SAME

(71) Applicant: Böllhoff Verbindungstechnik GmbH, Bielefeld (DE)

(72) Inventors: Sven Frömmer, Bielefeld (DE); Tim Flügge, Bad Salzuflen (DE)

(21) Appl. No.: 19/086,644

(22) Filed: Mar. 21, 2025

(30) Foreign Application Priority Data
Mar. 27, 2024 (EP) 24166943.1

(51) Int. Cl. F16B 19/08; F16B 19/04

(52) U.S. Cl. CPC F16B 19/086; F16B 2019/045

(57) ABSTRACT

A rivet for connecting at least two components arranged one upon the other and are not pre-punched. The rivet has ahead, a shaft, a foot and a length L of the rivet between 7 mm≤L≤16 mm. The shaft has an outer diameter D_{S} between 5.2 mm≤D_{S}≤5.6 mm, and a bore hole with diameter D_{B} between 3.1 mm≤D_{B}≤3.5 mm and depth T_{B} between 6 mm≤T_{B}≤15 mm. A bore hole volume V_{B} in the shaft between V_{Bmin}≤V_{B}≤V_{Bmax} with V_{Bmin}=7.3 [mm²]·L [mm] and V_{Bmax}=0.9 [mm²]·L [mm] arises. In an axial sectional view, the foot has a conical outer chamfer and a conical inner chamfer interconnected by a cutting edge, the inner chamfer transitions into an inner bore wall of the shaft via a circular arc section and the outer chamfer and the inner chamfer enclose a cutting angle W_{S} in the range from 80°≤W_{S}≤90°.

### CROSS REFERENCE TO RELATED APPLICATIONS

This application claims the priority to EP Patent Application No. EP24166943.1 filed on Mar. 27, 2024, and the entire content of this priority application is incorporated herein by reference in its entirety.

### TECHNICAL FIELD

The present disclosure is related to a semi-tubular/semi-hollow self-piercing rivet with which a connection between at least two components that are arranged stack-like one upon the other and are not pre-punched can be established. Furthermore, the present disclosure relates to a connection of at least two metal components that are arranged stack-like one upon the other and are connected with each other with the help of the semi-hollow self-piercing rivet. Furthermore, the present disclosure relates to a manufacturing method of the above-mentioned semi-hollow self-piercing rivet by means of cold forming.

### BACKGROUND

In the state of the art, there is a plurality of different rivet geometries, the individual constructive features of which are directed at implementing specific technical functions or targets in a self-piercing rivet connection.

EP 2 080 915 A2 discloses a relatively short semi-hollow self-piercing rivet with a length of 6.5 mm. This semi-hollow self-piercing rivet serves for connecting a high-strength cover sheet out of steel with an aluminum sheet arranged under it.

The semi-hollow self-piercing rivet of DE 10 2014 201 976 A1 is directed to the same connection out of high-strength cover sheet of steel and a thick-walled aluminum layer. With a rivet length of 5.5 mm, it does not use an acute cutting edge at the rivet foot in contrast to EP 2 080 915 A2. Rather, a plane shaft front surface is used despite an equal high-strength cover sheet, the cutting edge of which forms the end of the radial outer wall of the shaft. In comparison with EP 2 080 915 A2, this large-scale cutting surface requires a higher setting force.

Due to the short rivet length, these semi-hollow self-piercing rivets are not suitable for the connection of higher sheet stacks.

An equally short semi-hollow self-piercing rivet as the above-described is disclosed by WO 2011/023616 A1. With its limited length of 4.5 mm, the number or thickness of components to be connected is limited. Furthermore, the receiving volume of the shaft bore hole is too low to be suitable for higher sheet metal thicknesses.

Besides the disclosed semi-hollow self-piercing rivets of the above documents, WO 2023/057736 A1 describes, in addition to a semi-hollow self-piercing rivet with a total length of 6 mm, a hollow rivet with a total length of up to 11 mm. A hollow rivet has a receiving volume in the shaft that is open to the top, at the same time, however, it cannot guarantee a tight sealing connection. Furthermore, a hollow rivet lacks a stabilizing bridging effect of the rivet head. The same applies to the hollow rivet of WO 2014/013232.

EP 3 626 982 B1 discloses a semi-hollow self-piercing rivet for a stack of brittle materials with a large thickness. Accordingly, the semi-hollow self-piercing rivet has a length in the range from 11 to 12 mm. At the same time, an axial head thickness of 1.5 mm to 3.5 mm is too high, so that a part of the bore volume for receiving a punch slug gets lost. Furthermore, the shape of the rivet head and the rivet foot is adapted to the joining of brittle materials. The exclusively circular arc shaped transition of the countersunk head from the head underside into the radial shaft outer wall guarantees a lower increase of the diameter of the shaft during the transition into the countersunk head. By that, the radial pressure of the countersunk head on the brittle material is reduced while the semi-hollow self-piercing rivet is set and the countersunk head is pushed into the cover sheet. In a similar mechanically relieving manner as in case of the countersunk head geometry, the radially outside arranged circular arc of the rivet foot geometry guarantee a simplified radially outer slipping of the component material. This simplified or easier material slipping reduces the radially inwardly directed pressure of the component material on the shaft so that same can spread open more easily and earlier during the joining process.

The disadvantage of this is often that a widened rivet shaft does not sufficiently relieve the die cavity and is compressed in a damaging manner at the die.

US 2013/0336745 A1 describes a semi-hollow self-piercing rivet which is provided for connecting a higher stack of several sheets. The cylindrical shaft with a length of 10 mm is followed by a rivet head with an axial head thickness of 2.5 mm. While on the one hand, the rivet head stabilizes the rivet shaft, it blocks a part of an additional receiving volume in the shaft on the other hand. Therefore, the semi-hollow self-piercing rivet lacks effective space utilization in its construction.

EP 3 287 210 A2 discloses a further semi-hollow self-piercing rivet. It is characterized by a circular shaft which ends in a rivet head. The rivet head comprises a cylindrical head plate which axially closes the semi-hollow self-piercing rivet. It extends in a radial direction beyond the shaft. The side of the head plate which faces the shaft tangentially transitions into the outer side of the shaft like a circular arc. On the side of the head plate which faces the shaft, the circular arc like connection to the shaft only begins in the middle of the radial outside of shaft and head. By that, the semi-hollow self-piercing rivet can be set relatively deep, the shaft does, however, only absorb a small amount of the joining energy by means of a radial shaft widening in the direction of the rivet head or head plate, respectively. The disadvantage of this is that the semi-hollow self-piercing rivet is set too deep.

DE 10 2021 133 544 A1 describes a semi-hollow self-piercing rivet which due to its overall length is suitable for joining a higher stack of sheets. For stabilizing the shaft of the semi-hollow self-piercing rivet for such joining tasks, a radial thickness of the circumferential shaft wall increases axially in the direction of the rivet shaft. This advantageous stabilization does, however, also lead to a reduction of the receiving volume within the shaft bore hole in which the punch slug is received. This limited receiving volume can generate negative pressure tensions in the shaft which have a disadvantageous effect on the joining process.

With regard to the above discussed state of the art, it is therefore the object of at least some implementations of the present disclosure to provide a further improved semi-hollow self-piercing rivet which is suitable for connecting multi-layered sheet stacks of high thickness.

### SUMMARY

The above object is solved by a semi-hollow self-piercing rivet, a self-piercing rivet connection and by a manufacturing method for the self-piercing rivet. Advantageous embodiments and further developments result from the following description, the drawings as well as the appending claims.

The present disclosure includes a semi-hollow self-piercing rivet with which a connection between at least two components that are arranged one upon the other in a stack-like manner and are not pre-punched is establishable and which comprises the following features: a rivet head that is closed in axial direction, a rivet shaft extending from same, a rivet foot geometry at the end of the rivet shaft which faces away from the rivet head and an overall length L of the semi-hollow self-piercing rivet in the range from 7 mm≤L≤16 mm, the rivet head has a head diameter D_{K} in a range from 7.5 mm≤D_{K}≤7.9 mm, the form of a countersunk head with when viewed in axial cross section radially outside and starting in axial direction a cylindrical section, a truncated cone like section following the cylindrical section and an arc-like section tangentially transitioning into the rivet shaft and following the cone like section, the rivet shaft has a hollow cylindrical form with an outer shaft diameter D_{S} in the range from 5.2 mm≤D_{S}≤5.6 mm, a bore hole diameter D_{B} in the range from 3.1 mm≤D_{B}≤3.5 mm so that a relation of the bore hole diameter D_{S} to the head diameter D_{K} in the range from 0.39≤D_{B}/D_{K}≤0.5 arises, and with a bore hole depth T_{B} in the range from 6 mm≤T_{B}≤15 mm so that a bore hole volume V_{B} in the rivet shaft depending on the overall length L of the semi-hollow self-piercing rivet in the range from V_{B min}≥V_{B}≥V_{B max} with V_{B min}=7.3 [mm²]·L [mm] and V_{B max}=9.0 [mm²]·L [mm] arises, and in an axial sectional view, the rivet foot has a conical radial outer chamfer as well as a conical inner chamfer interconnected by means of a cutting edge, with the conical inner chamfer tangentially transitioning into a radially inner bore wall of the shaft via a circular arc section and the outer chamfer as well as the inner chamfer enclose a cutting angle W_{S} in the range from 80°≤W_{S}≤90°.

The present disclosure provides a semi-hollow self-piercing rivet of a large overall length, i.e. an overall length which significantly exceeds the known 5 mm or 6 mm long semi-hollow self-piercing rivets. With this large overall length, the requirement for connecting a large stack of sheets or of at least two sheets of large thickness which are arranged one upon the other is created. Furthermore, this overall length of the semi-hollow self-piercing rivet in combination with a cylindrical shaft bore hole of a large depth guarantees a sufficient receiving volume for the rising punch slug of the components to be connected with each other.

For this purpose, the semi-hollow self-piercing rivet was intentionally equipped with a countersunk head. The countersunk head is generated by directly subsequently arranging in joining direction a cylindrical section, a conical section and a section which is concave or arc like in axial cross section of the semi-hollow self-piercing rivet. With a low axial remaining head thickness, this countersunk head geometry allows the largest possible receiving volume of the shaft bore hole. At the same time, the semi-hollow self-piercing rivet is sealed and mechanically stabilized by means of the countersunk head which closes the shaft bore hole.

The rivet foot is characterized by a geometry which prevents the rivet shaft from spreading open too early at its end opposite to the rivet head, as a conical radial outer chamfer and a conical radial inner chamfer compensate the pressure of the punch slug entering the shaft bore hole and the component material surrounding the shaft with respect to one another. In order to maintain this compensation during the joining process, the conical inner chamfer tangentially transitions into the radial inner wall of the shaft bore hole via a circular arc section. The edgeless circular arc like transition allows the punch slug to slide into the shaft bore without it being frictionally blocked at the radial inner wall of the shaft bore hole.

According to a first configuration of the semi-hollow self-piercing rivet, the conical radial outer chamfer may have an outer chamfer height H_{S} as a function of the overall length L of the semi-hollow self-piercing rivet according to H_{S}=0.032·L [mm].

For being able to control a behavior of spreading open of the rivet shaft during a joining process, the size of the radial outer chamfer may be adapted. For this purpose, the axial height of the radial outer chamfer, i.e. the outer chamfer height, may increase, according to the given function, with an increasing overall length of the semi-hollow self-piercing rivet. For this purpose, the overall length L is entered into the function in the length unit millimeter.

With an increasing outer chamfer height, the surface of the outer chamfer, into which the component material engages, increases as well. As the component material may counteract a material displacement to the radial outside during the joining process, it stabilizes the rivet shaft by means of the outer chamfer surface against spreading open by the rising punch slug, alone.

The conical radial outer chamfer may have a radial outer chamfer width B_{S} in the range from 0.15 mm≤B_{S}≤0.35 mm.

For the further control of the spreading behavior of the rivet shaft, the surface size of the radial outer chamfer at the rivet foot is determined by the radial outer may be chamfer width. The radial outer chamfer width may be measured between the cutting edge and the radial cylindrical outer side of the rivet shaft elongated to the axial height of the cutting edge. By choosing the outer chamfer width from the given range, the outer chamfer surface is adaptable in its size so as to control the spreading behavior of the rivet shaft.

According to a further embodiment of the semi-hollow self-piercing rivet, the circular arc section may comprise, axially following the conical radial inner chamfer, an entry radius R_{S} into the shaft bore hole of 0.2 mm≤R_{S}≤1.1 mm, which may be 0.5 mm≤R_{S}≤1 mm.

The cutting edge of the rivet foot determines an approximate slug diameter which is received in the shaft bore hole while setting the semi-hollow self-piercing rivet into the at least two components. Setting test have shown that the punch slug which is displaced into the shaft bore hole often blocks at corners or edges at the radial inner wall of the shaft bore hole or is at least stopped or decelerated in its receiving movement into the shaft bore hole. In order to avoid such edges or corners, in which usually a radial conical inner chamfer ends at the radial inner wall of the shaft bore hole, the conical inner chamfer may transition in a circular arc like manner tangentially into the radial inner wall of the shaft bore hole.

The outer chamfer height H_{S} in relation to the entry radius R_{S} may lie in a range from 0.2≤H_{S}/R_{S}≤1.2.

While inserting the semi-hollow self-piercing rivet into the at least two components which are arranged one upon the other in joining direction, the circumferential wall of the rivet shaft is subject to different radial forces. Thus, the punch slug which rises in the shaft bore hole in the direction of the rivet head causes radial pressure forces to the outside. Furthermore, the displaced material of the component which engages at the radial outside generates pressure forces which are directed to the radial inside. An approximate balance between these radial pressure forces which are opposed to one another and/or a limitation of the power of these pressure forces may allow a reliable joining process. In order to guarantee this reliable joining process, the above-described relation of outer chamfer height and entry radius of the arc like section of the radial inner chamfer was recognized in a number of tests as a significant criterion.

According to a further embodiment of the semi-hollow self-piercing rivet based on the first configuration or a combination with this first configuration, a relation of shaft diameter D_{S} to head diameter D_{K} may lie in the range from 0.5≤D_{S}/D_{K}≤0.75.

For the rivet head to develop a sufficient retaining force for the punch slug at the component and for finishing the joining process, without it entering disadvantageously deep into same, the rivet head has a larger diameter than the rivet shaft. The head diameter may exceed the shaft diameter by 25% to 50%. Accordingly, the head diameter may exceed the shaft diameter by a quarter or twice of its size.

According to the disclosure, the rivet head which may be closed in axial direction has a minimum axial head thickness H_{K1}, i.e. a head thickness in axial direction of the semi-hollow self-piercing rivet, depending on the overall length L of the semi-hollow self-piercing rivet according to H_{K1}=0.1·L [mm]−0.1 mm.

In comparison with the hollow rivet, it has for example been shown that a closed rivet head provides for an additional stability in the rivet shaft. Furthermore, the rivet head prevents the punch slug from rising too far beyond the component surfaces. In order to avoid cracks in the rivet head due to mechanical tensions caused by the rising punch slug, the rivet head may have a head thickness H_{K1}, which may be defined depending on the overall length of the semi-hollow self-piercing rivet according to the above formula. With an increasing overall length of the semi-hollow self-piercing rivet, the size of the slug to be received increases, too. The higher mechanical loads of the rivet head which are preferably associated with this are compensated by an axial thickness of the rivet head which is adapted to the overall length.

According to a further configuration of the semi-hollow self-piercing rivet in combination with the above-described embodiments, the semi-hollow self-piercing rivet may have an overall length L in the range from 10.5 mm≤L≤16 mm.

It has been recognized that the semi-hollow self-piercing rivet may develop reliable connecting properties, which may be in a portion of its total length from 10.5 mm to 16 mm.

Furthermore, the present disclosure includes a connection of at least two metal components that are arranged stack-like one upon the other and which are connected with each other with the help of the semi-hollow self-piercing rivet according to at least one of the above-described configurations.

Furthermore, the present disclosure includes a manufacturing method of a semi-hollow self-piercing rivet which comprises the following steps: providing a wire section and cold forming a semi-hollow self-piercing rivet with the features of at least one of the above-described geometric configurations.

The manufacturing method of the semi-hollow self-piercing rivet is based on known methods of cold-forming a semi-hollow self-piercing rivet out of a wire section. The tools used for this purpose are adapted to the constructive features of the above-described semi-hollow self-piercing rivet in order to achieve the corresponding result, i.e. the advantageous constructive features of the semi-hollow self-piercing rivet.

The manufacturing method may comprise the further step: applying a corrosion protection layer onto a surface of the cold formed semi-hollow self-piercing rivet and/or applying a liquid coating to reduce a friction coefficient on a surface of the semi-hollow self-piercing rivet.

In order to support the above-described positive constructive characteristics with regard to their lifespan, a corrosion protection layer is additionally applied onto the cold formed semi-hollow self-piercing rivet. Alternatively or additionally to this, the surface of the semi-hollow self-piercing rivet is coated so as to reduce arising friction while contacting the semi-hollow self-piercing rivet. That way, the setting of the semi-hollow self-piercing rivet is facilitated and the associated energy effort is reduced.

### BRIEF DESCRIPTION OF THE DRAWINGS

The embodiments of the present disclosure are described in more detail based on the accompanying drawings. They show:

FIG. 1 a schematic sectional view of an embodiment of the semi-hollow self-piercing rivet,

FIG. 2 a further schematic sectional view of a further embodiment of the semi-hollow self-piercing rivet with dimensioning,

FIG. 3 a schematic illustration of a connection of at least two components arranged one upon the other with the help of the semi-hollow self-piercing rivet, and

FIG. 4 a flow chart of a further embodiment of a manufacturing method of the semi-hollow self-piercing rivet.

### DETAILED DESCRIPTION

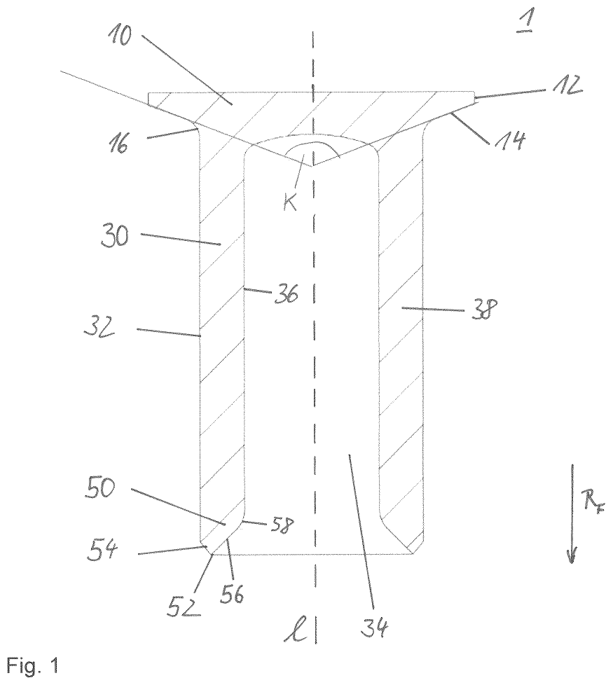

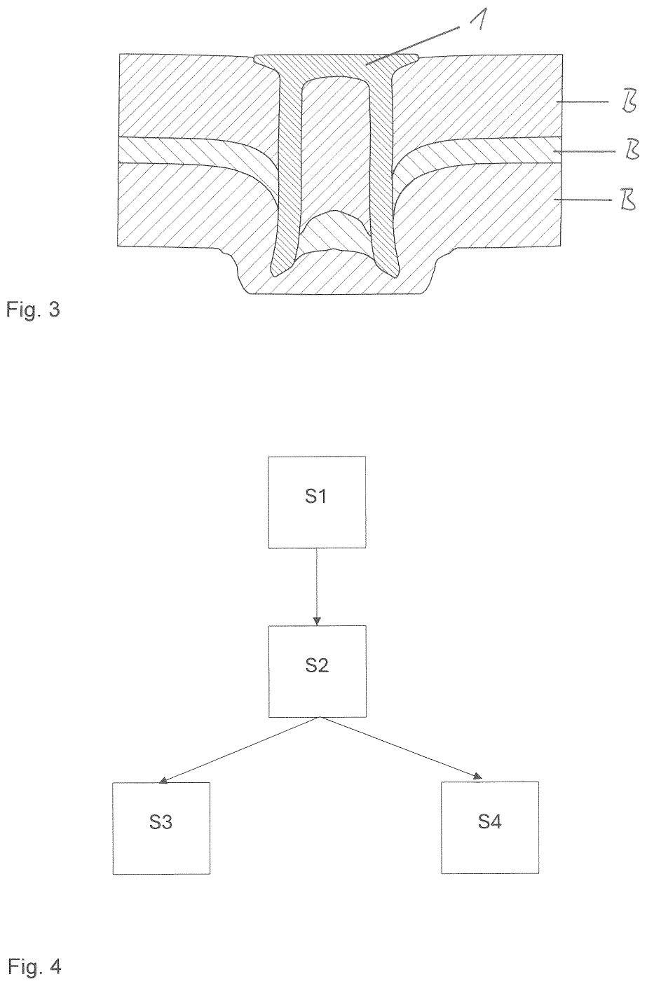

FIG. 1 shows a schematic illustration of an embodiment of the semi-hollow self-piercing rivet 1. At least two sheet layers which are arranged upon one another may be connected with the help of the semi-hollow self-piercing rivet 1. Such a connection between the components B with the help of the semi-hollow self-piercing rivet 1 is shown in FIG. 3. According to a further embodiment, at least one component B may be made of aluminum or an aluminum alloy.

The semi-hollow self-piercing rivet 1 comprises a rivet head 10 which is closed in axial direction, a rivet shaft 30 extending from the rivet head 10 and a rivet foot 50 axially concluding the rivet shaft 30. The axial direction of the semi-hollow self-piercing rivet 1 is illustrated by means of the dashed central longitudinal axis 1 in FIG. 1.

Due to the axially closed rivet head 10, the established connection of the components B is protected against corrosion as neither pollution nor humidity can enter the rivet shaft 30.

The semi-hollow self-piercing rivet 1 has an overall length L in the range from 7 mm≤L≤16 mm.

The rivet head 10 has a head diameter D_{K} in a range from 7.5 mm≤D_{K}≤7.9 mm.

Furthermore, the rivet head has the form of a countersunk head. In a joining direction R_{F}, viewed in an axial cross section of FIG. 1, the countersunk head is comprised of the following sections. At the end of the semi-hollow self-piercing rivet 1 which faces away from the rivet foot 50, the rivet head 10 has a cylindrical section 12 with a cylindrical lateral surface. This cylindrical section 12 is followed by a conical section 14 in joining direction R_{F}. The conical section 14 may enclose a cone angle K in a range from 120°≤K≤160°.

The conical section 14 tangentially transitions in an arc like section 16 into a radially outer lateral surface 32 of the rivet shaft 30.

A summarized axial extension H_{K2} of the three sections cylindrical section 12, conical section 14 and arc like section 16 may be smaller than an axial head thickness H_{K1}, which may be a minimum axial head thickness H_{K1}.

The minimum axial head thickness H_{K1} is the difference of the overall length L of the semi-hollow self-piercing rivet 1 and a bore hole depth T_{B} of a central shaft bore hole 34.

A reason for a larger minimum axial head thickness H_{K1} in comparison with the summarized axial extension H_{K2} is that otherwise, a material ingress could arise in a radially outer portion of the bore hole bottom of the central shaft bore hole 34 during cold molding or cold forming the semi-hollow self-piercing rivet 1 out of a wire blank. This would lead to a mechanical weakening of the semi-hollow self-piercing rivet 1.

According to a further embodiment of the semi-hollow self-piercing rivet 1, the closed rivet head 10 has the axial head thickness H_{K1} depending on the overall length L of the semi-hollow self-piercing rivet 1 according to H_{K1}=0.1·L [mm]-0.1 mm. For the application of the mentioned equation, the overall length L is given in millimeter, as is shown in square brackets.

According to a further embodiment of the semi-hollow self-piercing rivet 1, the minimum axial head thickness H_{K1} lies in a range from 0.9 mm≤H_{K1}≤3.1 mm.

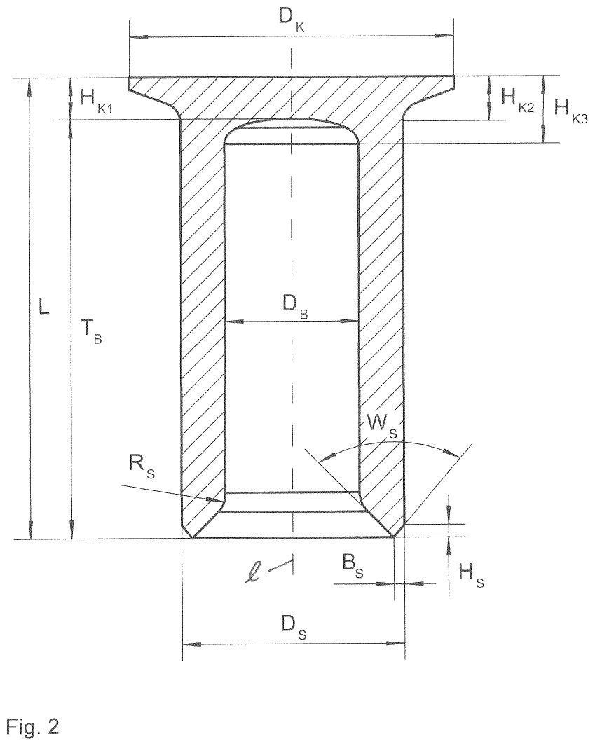

The rivet shaft 30 has the hollow-cylindrical shape which can be seen in the schematic sectional views of FIGS. 1 and 2. The hollow-cylindrical rivet shaft 30 has an outer diameter D_{S} in the range from 5.2 mm≤D_{S}≤5.6 mm.

The shaft bore hole 34 has a bore hole diameter D_{B} in the range from 3.1 mm≤D_{B}≤3.5 mm. Furthermore, the shaft bore hole 34 has a bore hole depth T_{B} in a range from 6 mm≤T_{B}≤15 mm. In this case, the bore hole depth T_{B} may be measured along the central longitudinal axis 1. Thus, the semi-hollow self-piercing rivet 1 may have a relation of bore hole depth T_{B} to the overall length L of the semi-hollow self-piercing rivet in the range from 0.7 to 0.95.

The main function of the deep bore hole is the material uptake of the displaced material from the components B. By means of a high material uptake, the necessary die volume is reduced and dies of a lower height can be used for the production of a punch rivet connection.

In addition, an insufficient material uptake of component material into the rivet bore hole 34 leads to an accumulation of component material in front of the rivet blade 52 during the joining process, which leads to deteriorated cutting properties of the rivet foot 50 (see below) and a potential clinching of blades.

Therefore, the semi-hollow self-piercing rivet 1 comprises a bore hole volume V_{B} in the rivet shaft 30 depending on the overall length L of the semi-hollow self-piercing rivet 1 in the range from V_{Bmin}≤V_{B}≤V_{Bmax} with V_{Bmin}=7.3 mm²·L [mm] and V_{Bmax}=9.0 mm²·L [mm].

In order to be able to take up sufficient material in the form of a punch slug within the bore hole 34 with the help of the available bore hole volume V_{B}, the above-defined bore hole diameter D_{B} of the shaft bore hole 34 is necessary. A specific wall thickness S_{W} of the rivet shaft 30 is necessary so that during the joining process, the semi-hollow self-piercing rivet 1 cuts over a long period of time with its rivet foot 50 and does not deform too early. This wall thickness S_{W} of the rivet shaft 30 arises from the equation S_{W}=½ (D_{S}−D_{B}), with the wall thickness S_{W} which may lie in a range from 0.85 mm≤S_{W}≤1.25 mm.

Tests have shown that it is advantageous when a quotient of bore hole diameter D_{B} and diameter D_{K} lies in a certain range. This range emphasizes a still sufficient head stability with the largest uptake volume of the shaft bore hole 34. Specifically, the relation of bore hole diameter D_{B} and head diameter D_{K} lies in a range of 0.39≤D_{B}/D_{K}≤0.5.

Furthermore, the range of the above relation equation emphasizes the correlation between firstly the energy effort for setting the semi-hollow self-piercing rivet 1, as the rivet shaft 30 with a shaft bore hole 34 of this diameter requires a high setting force or setting energy, respectively, for punching out the punch slug and for receiving the punch slug in the shaft bore hole 34.

The above relation equation emphasizes the correlation between secondly a controlled energy consumption during the setting process, because while the supply of the setting force and setting energy via a punch of a setting device starts the setting process, a countersunk head 10 which widens radially up to its head diameter may cause a conversion of the supplied setting energy into displacement energy of the component material of at least the cover sheet of the component stack. Thus, a determined head diameter D_{K} may provide for a specific reduction of setting energy that is still present.

The above observations regarding energy during the joining process, i.e. the alternating relation between the setting energy supplied to the semi-hollow self-piercing rivet 1 and the energy consumption by geometry-caused features of the semi-hollow self-piercing rivet 1 may be also expressed by a relation of the shaft diameter D_{S} to the head diameter D_{K}. According to a further embodiment, 0.5≤D_{S}/D_{K}≤0.75 may apply.

The semi-hollow self-piercing rivet 1 furthermore comprises a rivet foot 50 with a specific rivet foot geometry, the details of which are shown in FIGS. 1 and 2.

A rivet blade or cutting blade 52 may be needed so that thick and/or multi-layered metal sheet combinations and the associated material combinations may be joined. The cutting blade 52 separates the component material, thereby generating a punch slug. Furthermore, the cutting blade 52 which is influenced by the directly adjacent further constructive features of the rivet foot 50 must be capable of preventing a clinching of blades due to the component material to be separated. For this purpose, it is necessary that the rivet foot geometry is sufficiently stable so that it does not deform too early. Furthermore, this stability guarantees that in joining direction, the rivet foot 50 enters up to the last material sheet of the components B to be connected with each other.

For achieving the above goals, the cutting edge 52 is formed by a conical radial outer chamfer 54 and a conical radial inner chamfer 56. The outer chamfer 54 and the inner chamfer 56 may be configured linearly directly adjacent to the cutting edge 52 in axial cross section of the semi-hollow self-piercing rivet 1 and enclose a cutting angle W_{S} in the range from 80°≤W_{S}≤90°.

The conical radial inner chamfer 56 transitions tangentially into a radial inner bore wall 36 of the rivet shaft 30 via a circular arc section 58.

The conical radial outer chamfer 54, which may form or constitutes an annular surface which surrounds the rivet shaft 30 in a closed manner generates a pressure that is directed to the radial inside on the rivet foot 50 and thus on the rivet shaft 30 during the joining process. This radially inwards directed pressure on the shaft wall 38 may counteract a radially outwards directed pressure of the punch slug which enters the rivet shaft 30. Thus, a specifically adjusted size of the surface of the conical radial outer chamfer 54 prevents the rivet shaft 30 from spreading open too early.

In order to control the surface of the conical radial outer chamfer 54, the outer chamfer 54 may include a outer chamfer height H_{S} in axial cross section of the semi-hollow self-piercing rivet 1. According to FIG. 2, the outer chamfer height H_{S} is measured parallel to the central longitudinal axis 1 of the semi-hollow self-piercing rivet 1. It is determined by the axial distance between the rivet blade 52 and the point where the conical outer chamfer 54 meets the radial outer lateral surface 32 of the rivet shaft 30.

The outer chamfer height H_{S} may be determined depending on the overall length L of the semi-hollow self-piercing rivet 1 according to H_{S}=0.032·L [mm].

The surface of the outer chamfer 54 may be further determined by a radial outer chamfer width B_{S} in a range from 0.15 mm≤B_{S}≤0.35 mm.

As already mentioned above, the conical radial inner chamfer 56 tangentially transitions via a circular arc section 58 into the radial inner wall 36 of the shaft bore hole 34. The circular arc section 58 prevent the conical radial inner chamfer 56 and the radial inner wall 36 of the shaft bore hole 34 from forming an edge or an offset. In practice, it has been shown that the punch slug which rises in the shaft bore hole 34 tends to be blocked or impeded by such edges or offsets in the course of its rising movement.

According to a further embodiment, the circular arc section 58 may include a radius R_{S} in a range from 0.2 mm≤R_{S}≤1.1 mm. According to a further embodiment, the radius R_{S} may lie in a range from 0.5 mm≤R_{S}≤1 mm.

With this size and the course of the circular arc section 58, which are determined by the radius R_{S}, a balanced relation between the mechanical load which spreads open the rivet shaft 30 by means of the rising slug and the radially inwards acting forces of the displaced component material on the conical radial outer chamfer 54 may be created.

According to the disclosure, the above-mentioned balanced relation may be defined in numbers by a quotient of the outer chamfer height H_{S} and the entry radius R_{S}. This quotient may lie in a range from 0.2≤H_{S}/R_{S}≤1.2.

The above-described geometrical features of the semi-hollow self-piercing rivet 1 may have an advantageous effect when the semi-hollow self-piercing rivet 1 has an overall length L of 10.5 mm≤L≤16 mm.

According to a further embodiment, a liquid coating may be applied on the semi-hollow self-piercing rivet 1 for reducing a friction coefficient of its surface. This coating may fulfil two functions. Firstly, a rising of the punch slug in the shaft bore hole 34 is facilitated due to this coating. As the coating also reduces the friction at the radial outer lateral surface 32 of the rivet shaft 30, necessary setting forces for the semi-hollow self-piercing rivet 1 can be reduced with the coating.

In contrast to this, a high friction at the surface of the semi-hollow self-piercing rivet and a slow rising of the punch slug would lead to a material accumulation in front of the cutting edge 52, to a clinching of blades at the rivet foot 50 and to a potentially early spreading of the rivet shaft 30 during the joining process.

The coating may be comprised of two components: a corrosion resistant basic coating and a topcoat for adjusting the friction properties. The basic coating can be applied galvanically or mechanically. The topcoat is applied as a dry gliding film by means of a liquid coating.

Furthermore, the present disclosure comprises the connection which is schematically shown in FIG. 3, of at least two components B that are arranged stack-like one upon the other. They are connected with one another by means of the semi-hollow self-piercing rivet 1 according to one of the above-described embodiments.

Furthermore, the present disclosure includes the manufacturing method of the semi-hollow self-piercing rivet 1 according to the flow chart in FIG. 4. It comprises the following steps: providing a wire section (S1), cold forming a semi-hollow self-piercing rivet with the features of at least one of the above-described configurations (step S2), optionally applying a corrosion protection layer on the cold-formed semi-hollow self-piercing rivet 1 (step S3) and/or applying a liquid coating for reducing a friction coefficient of a surface of the semi-hollow self-piercing rivet 1 (step S4).

1. A semi-hollow self-piercing rivet with which a connection between at least two components that are arranged one upon the other in a stack-like manner and are not pre-punched is establishable and which comprises the following features:
a. a rivet head that is closed in axial direction, a rivet shaft extending from same, a rivet foot geometry at the end of the rivet shaft which faces away from the rivet head and an overall length L of the semi-hollow self-piercing rivet in the range from 7 mm≤L≤16 mm,
b. the rivet head has a head diameter D_{K} in a range from 7.5 mm≤D_{K}≤7.9 mm, the form of a countersunk head with when viewed in axial cross section radially outside and starting in axial direction a cylindrical section, a truncated cone like section following the cylindrical section and an arc-like section tangentially transitioning into the rivet shaft and following the cone like section,
c. the rivet shaft has a hollow cylindrical form with an outer shaft diameter D_{S} in the range from 5.2 mm≤D_{S}≤5.6 mm, a bore hole diameter D_{B} in the range from 3.1 mm≤D_{B}≤3.5 mm so that a relation of the bore hole diameter D_{S} to the head diameter D_{K} in the range from 0.39≤D_{B}/D_{K}≤0.5 arises, and with a bore hole depth T_{B} in the range from 6 mm≤T_{B}≤15 mm so that a bore hole volume V_{B} in the rivet shaft depending on the overall length L of the semi-hollow self-piercing rivet in the range from V_{B min}≤V_{B}≤V_{B max} with V_{B min}=7.3 [mm²]·L [mm] and V_{B max}=9.0 [mm²]·L [mm] arises,
d. in an axial sectional view, the rivet foot has a conical radial outer chamfer as well as a conical inner chamfer interconnected by means of a cutting edge, with the conical inner chamfer tangentially transitioning into a radially inner bore wall of the shaft via a circular arc section and the outer chamfer as well as the inner chamfer enclose a cutting angle W_{S} in the range from 80°≤W_{S}≤90°.

2. The semi-hollow self-piercing rivet according to claim 1, wherein the conical radial outer chamfer has an outer chamfer height H_{S} as a function of the overall length L of the semi-hollow self-piercing rivet according to H_{S}−0.032·L [mm].

3. The semi-hollow self-piercing rivet according to claim 2, wherein the conical radial outer chamfer has an outer chamfer width B_{S} in the range from 0.15 mm≤B_{S}≤0.35 mm.

4. The semi-hollow self-piercing rivet according to claim 3, wherein the circular arc section axially following the conical radial inner chamfer comprises an entry radius R_{S} into the shaft bore hole of 0.2 mm≤R_{S}≤1.1 mm.

5. The semi-hollow self-piercing rivet according to claim 4, wherein the outer chamfer height H_{S} in relation to the entry radius R_{S} lies in a range from 0.2≤H_{S}/R_{S}≤1.2.

6. The semi-hollow self-piercing rivet according to claim 1, wherein a relation of shaft diameter D_{S} to head diameter D_{K} lies in the range from 0.5≤D_{S}/D_{K}≤0.75.

7. The semi-hollow self-piercing rivet according to claim 1, wherein the rivet head which is closed in axial direction has an axial head thickness H_{K1} depending on the overall length L of the semi-hollow self-piercing rivet according to H_{K1}=0.1·L−0.1 mm.

8. The semi-hollow self-piercing rivet according to claim 1, having an overall length L in the range from 10.5 mm≤L≤16 mm.

9. A connection of at least two metal components that are arranged stack-like one upon the other and which are connected with each other with the help of the semi-hollow self-piercing rivet according to claim 1.

10. A manufacturing method of a semi-hollow self-piercing rivet which comprises the following steps:
a. providing a wire section and
b. cold forming a semi-hollow self-piercing rivet with the features of claim 1.

11. The manufacturing method according to claim 10 with the further step:
c. applying a corrosion protection layer onto the cold formed semi-hollow self-piercing rivet.

12. The manufacturing method according to claim 10 with the further step:
d. applying a liquid coating to reduce a friction coefficient of a surface of the semi-hollow self-piercing rivet.
